(19) United States
(12) Patent Application Publication
(10) Pub. No.: US 2003/0046855 A1
(43) Pub. Date: Mar. 13, 2003

(54) Portable hunting blind

(76) Inventor: Shirley Bergdall, Enid, OK (US)

Correspondence Address: MARTIN S. HIGH, P.O. BOX 217, STILLWATER, OK, 74076, US

(21) Appl. No.: 10/243,032

(22) Filed: Sep. 13, 2002

Related U.S. Application Data
(60) Provisional application No. 60/318,894, filed on Sep. 13, 2001.

(51) Int. Cl. A01M 1/00

(52) U.S. Cl. 43/1

(57) ABSTRACT

The instant invention, the portable hunting blind, is comprised of a tubular aluminum frame supporting a rip-stop, waterproofed, heavy-weight, camouflaged fabric covering. The portable hunting blind also comprises a comfortable fabric hunting chair when the portable hunting blind is unfolded. The hunter sits in the fabric hunting chair and can view the surrounding area via an opening in the front and roof of the portable hunting blind. Further, this opening can be covered with a removable rain visor that fully conceals the hunter from the surroundings.

### CROSS REFERENCE TO RELATED APPLICATIONS

This invention claims benefit of U.S. Provisional Application No. 60/318,894, which was filed on Sep. 13, 2001.

### BACKGROUND OF THE INVENTION

The field of the instant invention is hunting equipment. More specifically, the instant invention pertains to camouflaged hunting blinds. When hunters take the field in search of game, it is common practice for the hunters to camouflage themselves to make their presence in the field less intrusive and to preclude scaring the game. Since game birds have particularly good sense of sight, hunters in search of waterfowl or upland game birds are particularly interested in camouflage. One method of camouflaging oneself is the use of camouflage colored clothing. Unfortunately, this is not a good solution since even small motions allow game birds to sense the presence of hunters even if the hunters are wearing camouflaged clothing.

A more suitable solution to the hunter's desire for effective camouflage is to hide behind naturally occurring visual obstacles such as trees, bushes or rocks. This too is not a good solution since the natural obstacles preclude the hunter from properly observing the game birds. Furthermore, the naturally occurring obstacles may also preclude the hunter from bringing their firearms to a suitable position for aiming and firing. Finally, the naturally occurring obstacle may pose a safety hazard since the firearm may be inadvertently caught on the natural obstacle and thereby preventing the hunter from maintaining control of the firearm.

Another solution to acquiring suitable camouflage is a hunting blind. A hunting blind is a man-made enclosure in which a hunter can sit or stand and be hidden from the game. These enclosures can be permanently mounted in place such as on the ground or in a tree. Permanently mounted hunting blinds are typically rather large and heavy assemblies that cannot be easily transported. Indeed, to transport a permanent hunting blind a pickup truck or all-terrain vehicle is usually required. A permanent hunting blind is suitable if the hunter is interested in using a specific location as a hunting location, but if the hunter desires to move to different locations a permanent hunting blind is not suitable.

The use of temporary or portable hunting blinds is the typical solution to hunters who desire to change locations frequently. Previously disclosed portable hunting blinds have had several disadvantages. Most notably, the previously disclosed portable hunting blinds are too heavy to transport long distances or did not have sufficient room for the hunters to remain in the blind for long periods of time in a comfortable manner. Further, previous inventions do not have the features necessary for the hunters to view the field adequate nor have sufficient means to ventilate the hunting blind. The instant invention seeks to solve these problems by using lightweight materials and a novel design to permit easy transport.

### SUMMARY OF INVENTION

The instant invention, the portable hunting blind, is comprised of a tubular aluminum frame supporting a covering of woven, 500 denier, nylon, heavy-duty camouflaged fabric with a coating, such as polyurethane, on one side to make the covering waterproof. The portable hunting blind comfortably encloses a hunter and a hunting dog. The portable hunting blind also comprises a comfortable fabric hunting chair when the portable hunting blind is unfolded. The hunter sits in the fabric hunting chair and can view the surrounding area via an opening in the front and roof of the portable hunting blind. Further, this opening can be covered with a removable rain visor that fully conceals the hunter from the surroundings.

### BRIEF DESCRIPTION DRAWINGS

FIG. 1 is a perspective view of the tubular frame of the portable hunting blind with the fabric covering removed.

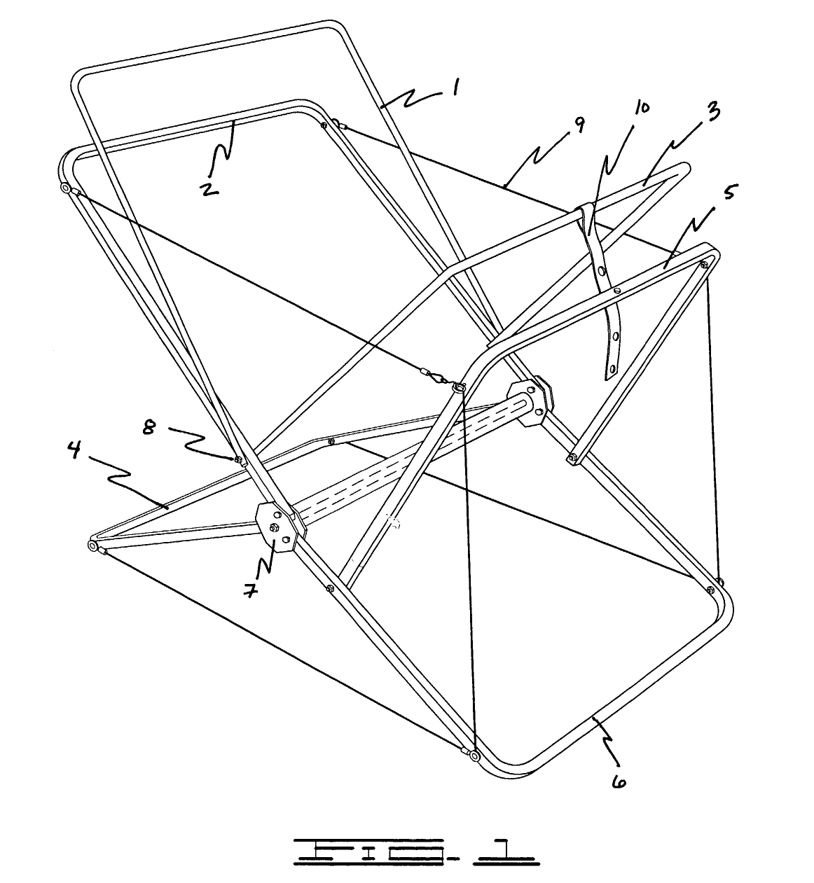

FIG. 2 is a side view of the portable hunting blind showing the configuration of the tubular aluminum frame with the blind in the deployed or open position.

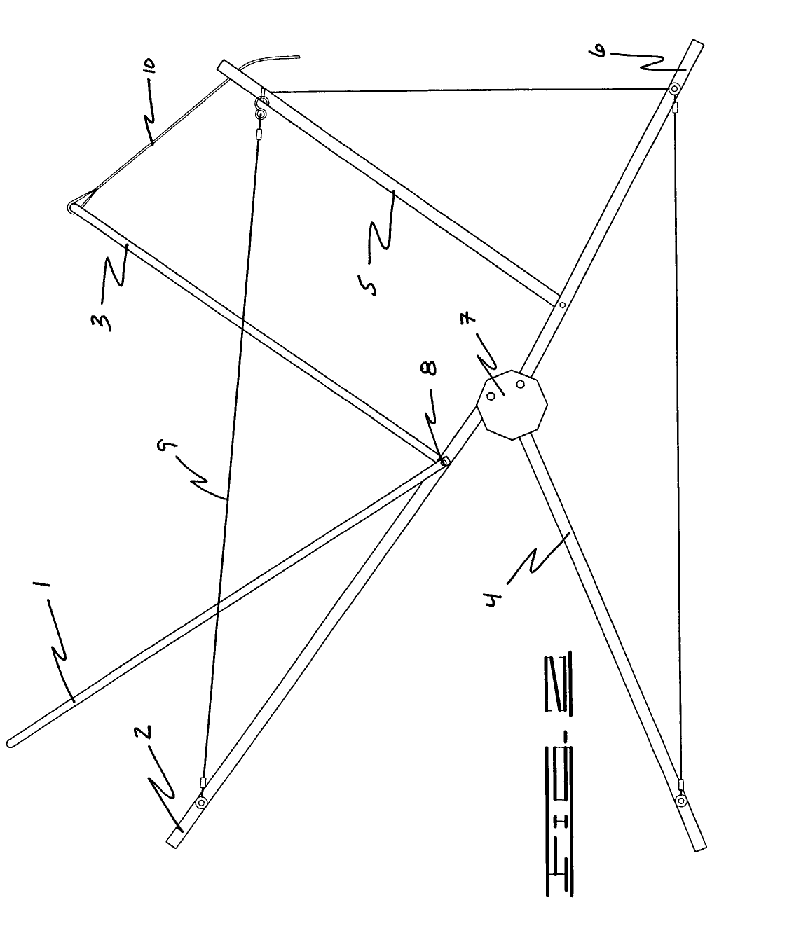

FIG. 3 is a view of the pivoting axis of the portable hunting blind showing the connections made with the supporting frame members

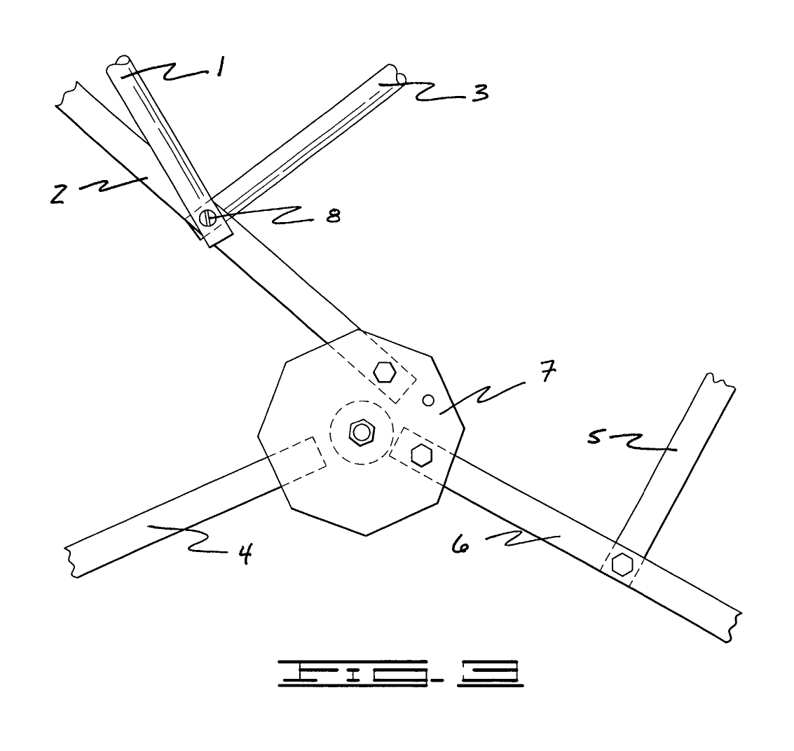

### DETAILED DESCRIPTION

The instant invention, the portable hunting blind, is comprised of a tubular aluminum frame and a woven, nylon, heavy-duty camouflaged fabric covering with a water proof coating on the back. The weight of the fabric is approximately 500 denier or heavier, and the waterproof coating is usually polyurethane or equivalent. The frame assembly is comprised of a base assembly and a fabric support assembly both of which are connected to a pivoting axis 7.

The base assembly is comprised of two tubular base supports, a front base support 6 and a rear base support 4, that are constructed from large cross-section, square channel aluminum tubing in an approximately “U-shaped” arrangement. These base supports are both connected to the main pivoting axis 7 of the portable hunting blind.

The fabric support assembly is comprised of two large cross-section, square channel aluminum tubing units and two small cross-section, circular aluminum tubing units that form an approximately “U-shaped” arrangement. The square channel tubing is between 0.5 inch and 1.0 inch square. The small cross-section, circular aluminum tubing is between 0.25 and 0.75 inch in diameter. One of the two large cross-section, square channel aluminum tubing units form a front large fabric support 5 and the other forms a rear large fabric support 2. One of the two small cross-section, square channel aluminum tubing units form a front small fabric support 3 and the other forms a rear small fabric support 1. The front large fabric support 5 is connected to the front base support 6 using threaded connectors on both sides of the “U-shaped” arrangement. The front small fabric support 3 and rear small fabric support 1 are connected to the rear large fabric support 2 at the similar locations on either side of the “U-shaped” arrangement via a threaded connection 8. The rear large fabric support is in turn connected to the main pivoting axis 7. When deployed the base assembly and fabric support form a frame to fully support the fabric covering. Further, the base assembly supports a fabric chair inside of the frame formed from the fabric support.

A frame support wire 9 is connected in turn to the end of the rear base support, the end of the front base support, near the top of the front large fabric support and near the top of the rear large fabric support. A frame support wire 9 is located on both sides of the frame of the portable hunting blind. When the frame of the portable hunting blind is fully deployed, the two frame support wires 9 are under tension and prevent the frame from opening further and support the fabric covering over the hunter. When a hunter is seated in the interior fabric chair the tension of the wire maintains the shape of the base and fabric support assemblies.

The pivoting axis of the portable hunting blind allows the base assembly and the fabric support assembly to fold into a compact unit or fully deploy to form a frame to hold the fabric covering. The pivoting axis also connects the sides of the portable hunting blind through the central portion of the frame. All connections in the portable hunting blind are comprised of threaded or equivalent connectors.

The interior fabric hunting chair is comprised of the same material of which the fabric covering is comprised. The hunting chair is constructed such that the front of the chair loops around and is supported by the frame pivot axis. The rear of the chair is attached to the nylon straps that are in turn connected to the top, rear portion of the rear fabric support. The nylon straps are adjustable to allow for increasing the tension in the fabric chair.

The construction of the fabric for the blind is made in four sections. The top and back of the blind are comprised of 2 inch diameter tubing and the front portion of the cover is made to accommodate the front round tube. On the front round tube is mounted a strip of 1 inch hook and loop fastener which is sewed on the edge so that the windshields can be secured. Two hook and loop tabs are sewed on each side of the roof seem in order to secure the side flaps for side visibility when the side flaps are secured. The head rod is made of ½ inch diameter aluminum tubing. Just below the seat rod tube is an 8 inch by 12 inch window that has a hook and loop fastener closure.

The sidepieces are comprised of two sub units. They are combined with the use of a zipper fastener that can be opened for ventilation. A grommet in the side is used to attach the top side flaps and the side of the cover to the frame. The front subunit is made with a 2″ tube that accommodates the front bar of square aluminum that has a hold down latch that the top hold down strap 10 is attached to when the blind is pulled down. On the front piece there is a pocket that is used for storage of the net windshield and other incidentals. This pocket is secured closed with hook and loop fasteners. The top of the blind contains four elastic straps that are sewed around the front tube and stretched to the back of the roof and sewed around the tubes that support the seat bar. These elastic straps allow the top portion of the blind to be spring loaded so that it can be quickly and easily opened for shooting at game. Also on the front bar of the front piece is attached a rubber pad that is covered and attached to the front bar with wire ties. This pad can be used to allow the hunter to rest the gun while shooting.

The floor of the blind is 18 oz. waterproof vinyl or nylon material. Attached to the corners of the floor are four hold down straps that can be staked to the ground in the event of high winds. A vinyl sheet with a camouflaged netting sewed over the opening so that it can be secured on the front or the top when it is raining or cold. There is a flap sewed to each side of the top. These flaps can be secured with hook and loop fastener to the sides or they can be folded up for visibility and ventilation.

A best mode of use of the instant invention is for the hunter to carry the portable hunting blind into the field and unfold the base assembly and the fabric support assembly. In this best mode, the fabric covering is installed onto the base assembly and fabric support and unfolds with the base assembly and fabric support. The hunter then can unfasten the hook and loop fasteners to the side pieces and step into the portable hunting blind and sit on the fabric chair. Depending on the weather and hunting conditions, the hunter could leave the side pieces fastened to the sides or rolled up to allow for added visibility, movement or ventilation. The windshields can be removed for added ventilation or installed in inclement weather.

What is claimed is:

1) A portable hunting blind comprised of:
a frame assembly comprised of a base assembly and a fabric support assembly both of which are connected to a pivoting axis;
the fabric support assembly supports a camouflaged fabric covering;
the fabric covering is comprised of side pieces, a roof covering, and a front covering made from woven, waterproofed, heavy-weight fabric;
a comfortable fabric hunting chair which unfolds when the portable hunting blind is unfolded;
an opening formed in the front covering and roof covering of the portable hunting blind which can be covered with a removable rain visor.

2) A portable hunting blind as described in claim 1 wherein the base assembly is comprised of a front base support and a rear base support both constructed from 0.7 to 1.0 inch square cross-section, channel aluminum tubing in an approximately U-shaped arrangement where the front base support and the rear base support are both connected to a pivoting axis.

3) A portable hunting blind as described in claim 2 wherein the fabric support assembly is further comprised of
a front large fabric support manufactured from 0.7 to 1.0 inch square cross-section, channel aluminum tubing forming an approximate U-shape;
a rear large fabric support manufactured from 0.7 to 1.0 inch square cross-section, channel aluminum tubing forming an approximate U-shape;
a front small fabric support manufactured from 0.25 to 0.75 inch cross-section, circular aluminum tubing units forming an approximate U-shaped;
a rear small fabric support manufactured from 0.25 to 0.75 inch cross-section, circular aluminum tubing units forming an approximate U-shaped;
the front large fabric support is connected to the front base support using threaded connectors on both sides of the front large fabric support;
the front and rear small fabric supports are connected to the rear large fabric support at the same location on either side of the rear large fabric support;
the rear large fabric support is connected to the pivoting axis;
the base assembly and fabric support form a frame to fully supports the fabric covering;
the fabric covering forms an fabric chair inside of the frame.

4) A portable hunting blind as described in claim 3 further comprising a frame support wire connected to the end of the rear base support, the end of the front base support, near the top of the front large fabric support and near the top of the rear large fabric support such that when a hunter is seated in the interior fabric chair the tension of the wire maintains the shape of the base and fabric support assemblies.
